(19) United States
(12) Patent Application Publication
(10) Pub. No.: US 2006/0230762 A1
(43) Pub. Date: Oct. 19, 2006

(54) Control of a gas turbine with hot-air reactor

(75) Inventor: Stellan Hamrin, Kungsor (SE)

Correspondence Address: VENABLE LLP, P.O. BOX 34385, WASHINGTON, DC, 20045-9998, US

(73) Assignees: ALSTOM POWER SWEDEN AB, Finspang (SE); NORSK HYDRO ASA, Oslo (NO)

(21) Appl. No.: 10/542,340

(22) PCT Filed: Jan. 19, 2004
(86) PCT No.: PCT/SE04/00058

§ 371 Date: Apr. 17, 2006

(30) Foreign Application Priority Data
Jan. 20, 2003 (SE) 0300131-0

(51) Int. Cl. F02C 1/04

(52) U.S. Cl. 60/650

(57) ABSTRACT

A method for producing, on an SiC substrate, SiC homoepitaxial layers of the same polytype as the substrate. The layers are grown on a surface of the SiC substrate, wherein the surface is inclined relative to the (0001) basal plane at an angle higher than 0.1 degree but less than 1 degree. An homoepitaxial growth is started by forming a boundary layer with a thickness up to 1 μm.

### TECHNICAL FIELD

The invention relates to a gas turbine in which combustion of a fuel takes place in a slow reactor, that is to say a reactor which cannot be rapidly controlled in the event of load fluctuations, for example by controlling the fuel supply. The invention relates in particular to an arrangement and a method for controlling a gas turbine in different operating situations occurring in the use of such a reactor.

### PRIOR ART

A special gas turbine-based power generating process is proposed using a concept known by the abbreviation AZEP (Advanced Zero Emissions Power Plant). This process represents a cost-effective way of reducing local and global emissions. The innovative cycle on which the process is based makes it possible to reduce the carbon dioxide (CO₂) emissions by 100%. A number of complementary additions allow conventional air-based gas turbine equipment to be used for power generation. The loss in plant efficiency is less than 2%. The key to achieving these objectives is the development of a reactor integrated with a gas turbine, in which oxygen (O₂) is separated from the air in the reactor, so that combustion of a fuel can take place in a nitrogen-free environment.

The AZEP concept will not be described further in this document, since the concept sets forth a known process. As an example of the prior art, reference will be made here to an article from the “Second Nordic Minisymposium on Carbon Dioxide Capture and Storage” held in Gothenburg on 26 Oct., 2001 and entitled “AZEP—Development of an Integrated Air Separation Membrane—Gas Turbine”, by the authors Sundkvist, Griffin and Thorsaug. Everything described in the said article is hereby incorporated into the present specification.

The AZEP concept proposes a process for generating power with zero emissions. The use of a so-called Mixed Conducting Membrane (MCM) provides a solution to this. This membrane produces pure oxygen from air. Research centred on these oxygen-selective membranes has increased markedly in recent years. The MCM membranes are made up of complex crystalline structures, which contain vacancies and oxygen ions. The principle on which oxygen ions are transported through a membrane involves surface adsorption followed by decomposition into ions which are transported through the membrane by a sequential occupation of ion vacancies. The transport of ions is counterbalanced by a flow of electrons through the membrane in the opposite direction. The motive force is a difference between the partial pressure of the oxygen on both sides of the membrane. The transport furthermore requires high temperatures in excess of 700° C.

The integration of MCM technology into power plants can be achieved by various means. A number of solutions with separated cycles characterised by different cycle efficiencies have been studied and compared with the best possible existing technologies. This has shown that the most efficient, cost-effective and promising application of an MCM reactor is to integrate it into a conventional gas turbine. The MCM reactor, which combines oxygen separation, combustion and heat transfer processes, is thereby intended to replace the conventional burners in a gas turbine power plant of standard design, as is shown in FIG. 1. The gas turbine set and its auxiliary equipment consist of standard arrangements. FIG. 1 shows the basic setup of said concept with a gas turbine using methane combustion in an MCM reactor. Air is fed to a compressor C, from whence the compressed, heated air is delivered to the reactor 1. In the reactor 1 a gas, in this case methane, is burnt. Heat from the combustion raises the temperature of the air fed to the reactor, following which the hot air drives a gas turbine T. Useful power is utilised by a generator G mounted on the same shaft as the compressor and the gas turbine. Extending through the length of the reactor is an MCM membrane M. Oxygen is transported through the membrane in the figure from the so-called air-circuit of the reactor 1 towards the sweep circuit of the reactor. In the sweep circuit the gas is burned in a reaction with oxygen, following which the combustion gases, largely carbon dioxide and water, give off heat via a heat exchanger and are then delivered to a turbine T2, which is driven by the combustion gases. The water and the carbon dioxide are then taken up by equipment (not shown), downstream of the outlet 2.

One problem that has to be overcome in order to drive a gas turbine with an MCM reactor is how to control the plant. In a conventional gas turbine generating a hot gas, as distinct from the generation of hot air in the present plant, the gas turbine is readily controlled by regulating the fuel supply to one or more burners between compressor and gas turbine according to the load requirements. Such control is impossible with the very slow type of reactor represented by an MCM reactor. That is to say rapid changes in the power output which it delivers to the gas turbine are not possible. An object of the present invention is to demonstrate a solution to this problem.

### SUMMARY OF THE INVENTION

A first aspect of the invention sets forth an arrangement for controlling a gas turbine, the burner of which consists of a reactor which is preferably maintained at a constant temperature, the arrangement being characterized by the characteristic features according to the independent device claim.

A second aspect of the invention sets forth a method for controlling said plant according to the independent method claim.

Arranging the AZEP reactor separate from the gas turbine makes it possible to achieve a rapid separation of the gas turbine from the reactor in respect of the load.

The general object of the aspects of the invention is to keep the temperature of the reactor stable, quite simply by controlling the output from the reactor burner and also controlling the mass flow through the sweep circuit in the reactor. The pressure in the seep circuit is kept at a constant level in relation to the pressure in the air ducts of the reactor. This is achieved by controlling the ordinary gas output and, in extreme situations, a gas blow-off valve. If the increase in pressure from the gas turbine compressor is more rapid than can be produced by feeding fuel into the sweep circuit, additional steam injection into the reactor must be considered.

The turbine and its compressor are controlled by means of the conventional blow-off outlets and the rotatable guide vanes in the compressor and by controlling the turbine inlet temperature. According to the aspect of the invention the temperature is controlled by means of a valve set, which controls a mixture of hot air from the reactor and air from the compressor, which has been made to bypass the reactor via the valve set. One set of valves may be sufficient if the air flow resistance as the air flows through the reactor can be such that the temperature of the air to the turbine is low enough for all loads when the regulating valve that bypasses the reactor is fully open. If the flow resistance through the reactor is too low, an additional valve set must be arranged in the cold air passage to the reactor.

Apart from the slowness of the reactor, a major advantage in being able to maintain the reactor at the high temperature when controlling the plant is that it is possible to extract oxygen from the air for the combustion process in the sweep circuit without the need to supply additional oxygen, which becomes necessary if the temperature in the reactor is reduced in an attempt to control the plant with the aid of adjustments to the running of the reactor.

Further examples of the working of the gas turbine control disclosed and its application in various operating situations will be demonstrated with reference to the following examples of embodiment.

### DESCRIPTION OF THE DRAWINGS

FIG. 1 shows a gas turbine plant with an MCM reactor proposed in the prior art.

FIG. 2 in a schematic and symbolic diagram shows how a gas turbine plant according to the aspects of the invention is arranged.

FIG. 3 illustrates a gas turbine plant according to the invention, showing the various gas flows in gas turbine and reactor more clearly.

### EXAMPLES OF EMBODIMENTS OF THE INVENTION

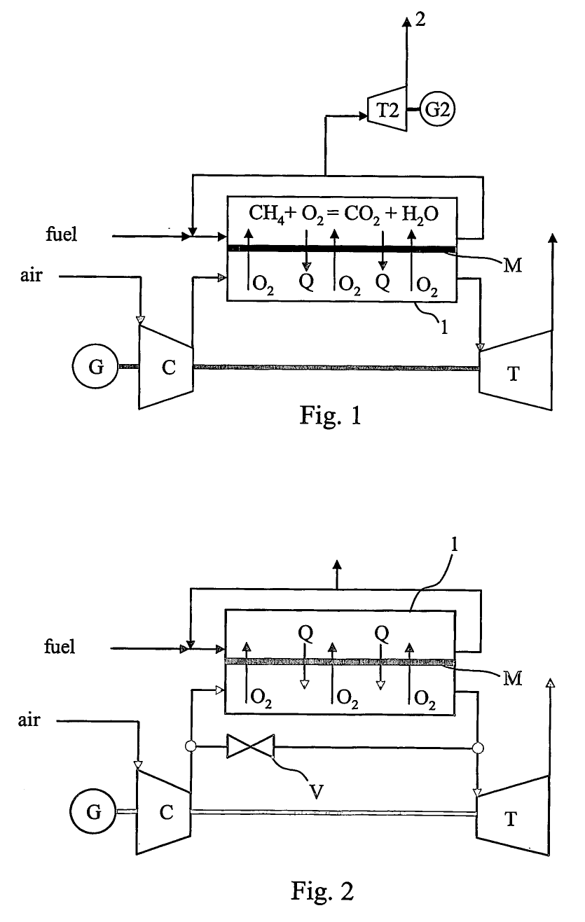

The invention will be described below with reference to the drawings attached. An arrangement in the form of a gas turbine plant, which is controlled according to the aspects of the invention, is shown in FIG. 1 described above.

The arrangement for controlling the plant is shown in schematic form in FIG. 2. In the said figure C represents a compressor for compressing air, which after compression is delivered at increased pressure and higher temperature to an MCM reactor 1 according to the prior art. In the reactor 1 a fuel, in this case methane gas, is burned. The reactor comprises a heat exchanger, which gives off heat from the sweep circuit in the reactor to the air in the air circuit via the membrane M, which divides the reactor into a sweep circuit side and an air circuit side. The temperature of the air is thereby increased to around 1250° C. This heated air drives the gas turbine T. In order to be able to control the plant reliably and in different types of operating situation, according to the aspect of the invention a regulating valve V is arranged in parallel with the reactor 1. The regulating valve V is preferably located on the cold side of the air circuit. The regulating valve V can thus be used to short-circuit the air flow over the reactor 1. This makes it possible to control the temperature at the inlet to the gas turbine T entirely within the temperature range that is defined by the lower temperature at the outlet of the compressor C and the higher temperature at the outlet of the reactor 1, which is normally kept at approximately 1250° C. As stated, it is advantageous to maintain the process in the reactor at a largely constant high temperature. In this way the operation of the reactor can be isolated from actual control of the load uptake from the gas turbine. By using the regulating valve V to mix the cooler air from the compressor C with the hot air from the reactor 1, the load of the gas turbine T can be controlled in the desired way.

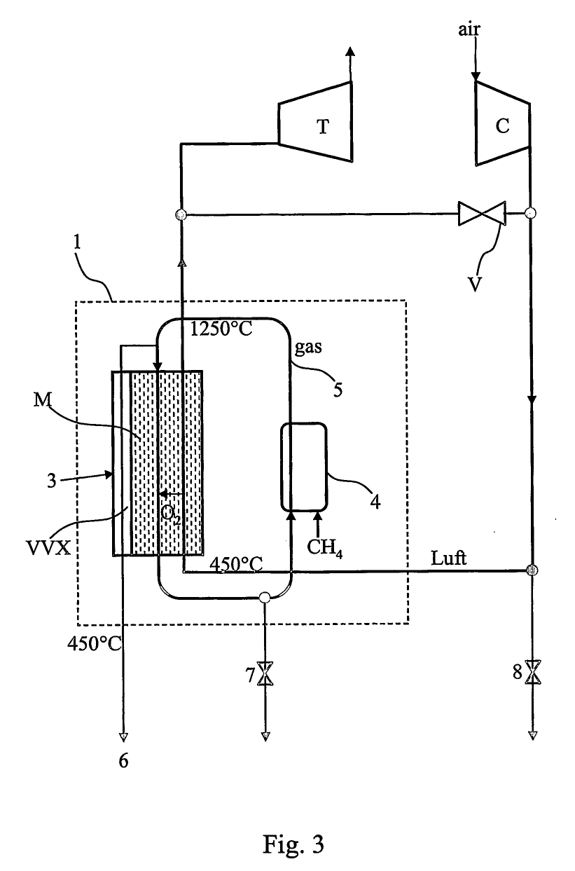

FIG. 3 shows the gas and air flows through the plant according to the invention more clearly. The compressed air from the compressor C is fed into the reactor 1 through a core 3, which contains the membrane M. This membrane contains a large number of parallel, pore-like ducts for air and for gas. Each air duct is surrounded by gas ducts and vice-versa. The process described above for transporting oxygen from air to gas takes place in the material between the air ducts and the gas ducts. The core 3 also contains a heat exchanger VVX, which transfers heat from the hot gas to the air, so that the air is thereby heated to approximately 1250° C. before the hot air is delivered to the turbine T. The hot gas is produced in one or more burners 4, which are included in the reactor 1. In the example shown the gas consists of methane which is burned in the burner 4. Also running through the burner 4 is a sweep circuit 5. The gas in this sweep circuit 5 is produced in the burner 4, following which the hot gas gives off heat via the heat exchanger VVX in the core 3 of the reactor 1. Due to the addition of oxygen from the air in the air circuit via the membrane M, the gas in the sweep circuit becomes oxygen-enriched and is capable of maintaining the combustion in the burner 4 to where the gas is fed from the core 3. After giving off heat, the gas has been cooled to approximately 450° C. before it reaches the burner 4. Used gas is also led off via a line 6 to the turbine T2 shown in FIG. 1, which further utilizes the heat, following which the gas is transported further for processing of its carbon dioxide and water content. The figure also shows a gas blow-off valve 7 for releasing gas from the sweep circuit. Also shown is an air blow-off valve 8 for releasing air from the air circuit.

A number of different plant operating situations are described below.

In the event of a load change the temperature in the sweep circuit of the reactor must be kept constantly at maximum temperature. The mass flow in the reactor sweep circuit is maintained so that the heat capacity flow in the sweep circuit is equal to the heat capacity flow in the air circuit of the reactor.

In the case of a hot shutdown of the plant, in which access to the reactor is not required, the reactor 1 is isolated from the turbine T. This is done in that the air flow over the reactor is short-circuited outside the reactor by fully opening the regulating valve V. A small air flow through the reactor is still maintained so as to keep up the temperature profile of the reactor and in order to keep burners at the inlet to the sweep circuit at full load temperature.

The reactor 1 can be shut down in several different ways. An emergency shutdown, as a result of a turbine failure, for example, can be achieved by isolating the turbine from the reactor in the same way as in the hot shutdown. In this case, however, the reactor is shut off quite simply by shutting off the burners. If necessary, the circulation in the sweep circuit can also be shut down. Another alternative for shutting down the reactor which allows more rapid access to the reactor and its core is for the burners and the circulation in the sweep circuit to be shut off, but for the turbine to gradually extract heat from the reactor so that it is consequently cooled.

In a gas turbine trip in which it is necessary to resort to a hot shutdown of the plant, the regulating valve V is fully opened in order that the inlet temperature to the gas turbine T will be reduced and an air blow-off valve 8 is also opened in order to rapidly reduce the temperature in the gas turbine. The regulating valve V according to the invention is shown fitted between the hot and cold side of the air circuit, as described above.

1. A gas turbine plant, comprising:
a compressor, a turbine and a reactor for heating air, in which air is compressed in the compressor and together with a fuel is delivered to the reactor in order to maintain combustion, and in which the air heated in the reactor drives the turbine, wherein control of a load of the turbine comprises controlling an inlet temperature to the turbine by mixing hot air from the reactor with air from the compressor by means of a regulating valve arranged between an outlet of the compressor and the inlet of the turbine.

2. The gas turbine plant according to claim 1, wherein the reactor is an MCM reactor.

3. The gas turbine plant according to claim 1, wherein the regulating valve is fitted in a line which bypasses an air circuit of the reactor.

4. The gas turbine plant according to claim 3, wherein the regulating valve is fitted closer to the cooler side of said bypass line.

5. The gas turbine plant according to claim 2, wherein the MCM reactor comprises an air circuit which leads air from the compressor along a first side of a membrane, which transports oxygen from the air to a hot gas on the other opposite side of the membrane and wherein as the air in the air circuit passes through the reactor it is heated by a heat exchanger inside the reactor.

6. The gas turbine plant according to claim 5, wherein the reactor comprises a sweep circuit, which includes at least one burner in which the fuel is burned and generates a hot gas in the sweep circuit, and wherein the hot gas is led through the reactor on the other side of said membrane, where it is enriched with oxygen and the hot gas in the sweep circuit gives off heat to the air in the heat exchanger before the cooled gas is delivered to an outlet.

7. The gas turbine plant according to claim 6, wherein the sweep circuit comprises a blow-off valve.

8. The gas turbine plant according to claim 5, wherein the air circuit comprises an air blow-off valve.

9. The gas turbine plant according to claim 1, wherein the reactor is kept at a temperature corresponding to the full load of the reactor.

10. The gas turbine plant according to claim 9, wherein said temperature is maintained by controlling the flow of air and fuel through the reactor.

11. A method of controlling the load in a gas turbine plant, comprising:
air is compressed in a compressor,
the compressed air is led through an air circuit in a reactor which comprises an MCM membrane,
a fuel is delivered to a burner in a sweep circuit in the reactor where a hot gas is formed by a combustion in the burner,
the hot gas is made to give off heat to the air in the air circuit via a heat exchanger in the reactor,
in the reactor the hot gas is enriched with oxygen which is transported to the sweep circuit from the air in the air circuit via the membrane,
the air heated in the reactor is led off to an inlet of a gas turbine in order to drive the gas turbine,
controlling a load in the plant by controlling a regulating valve, which allows air direct from the outlet of the compressor to be mixed with hot air from the reactor, so that the temperature of the air to the inlet of the gas turbine can be controlled as a function of the load uptake from the gas turbine.

12. The method according to claim 11, wherein the regulating valve sets the temperature at the inlet to the gas turbine to between 450° C. and 1250° C.

13. The method according to claim 11, wherein the reactor (1) is allowed to operate at a temperature corresponding to full load when controlling load changes of the gas turbine.

14. The method according to claim 11, wherein a rapid shutdown of the plant can be achieved by fully opening the regulating valve so that virtually all the air from the compressor bypasses the reactor.

15. The method according to claim 11, wherein a rapid shutdown of the gas turbine can be achieved by fully opening the regulating valve so that virtually all the air from the compressor bypasses the reactor.
